(19) United States
(12) Patent Application Publication
(10) Pub. No.: US 2016/0333609 A1
(43) Pub. Date: Nov. 17, 2016

(54) LID LOCKING MECHANISM

(71) Applicant: Cobalt Utility Products, Inc., Issaquah, WA (US)

(72) Inventors: Richard VanDeMark, Issaquah, WA (US); Gary Lee Hanson, Sammamish, WA (US); Richard Carlson, Monroe, WA (US); Mark Mason, Kirkland, WA (US)

(73) Assignee: Cobalt Utility Products, Inc., Issaquah, WA (US)

(21) Appl. No.: 15/153,619

(22) Filed: May 12, 2016

Related U.S. Application Data
(60) Provisional application No. 62/221,208, filed on Sep. 21, 2015.
(60) Provisional application No. 62/161,803, filed on May 14, 2015.

(51) Int. Cl. E05B 65/00; E05C 3/02

(52) U.S. Cl. CPC E05B 65/006; E05C 3/02

(57) ABSTRACT

A locking apparatus for a lid comprising a fastener having threads and a friction element embedded within a portion of the fastener. A toggle having a threaded hole therein, wherein the fastener is rotatively inserted through the threaded hole of the toggle to translate the rotational movement of the fastener into linear movement of the toggle. The friction element causes the toggle to engage the fastener to translate the rotational movement of the fastener to the toggle. A torque assembly to apply a compression force against the fastener to restrict linear motion of the fastener and create a rotating resistance of the fastener. A bolster coupled to the torque assembly to restrict the rotational movement of the toggle and apply the compression force of the torque assembly against an underside of the lid.

### CROSS-REFERENCE TO RELATED APPLICATIONS

This application claims benefit under 35 USC 119(e) from U.S. Provisional Patent Application No. 62/221,208 filed on Sep. 21, 2015, entitled “BOX SECURITY LID LOCKING METHOD AND APPARATUS FOR LOCKING REMOVABLE LIDS” and claims benefit under 35 USC 119(e) from U.S. Provisional Patent Application No. 62/161,803 filed on May 14, 2015, entitled “BOX SECURITY LID LOCKING METHOD AND APPARATUS FOR LOCKING REMOVABLE LIDS.”

### SUMMARY

According to one aspect, a locking apparatus for a lid, comprising a fastener having threads and a friction element embedded within a portion of the fastener, the fastener having a head and an end positioned opposite the head, the head capable of being engaged to rotatively actuate the fastener; a toggle having a threaded hole therein, wherein the fastener is rotatively inserted through the threaded hole of the toggle, the fastener threads rotatively engage with the threaded hole of the toggle to translate the rotational movement of the fastener into linear movement of the toggle, wherein the friction element causes the toggle to engage the fastener to translate the rotational movement of the fastener to the toggle; a torque assembly mated to the end of the fastener, wherein the torque assembly applies a compression force against the fastener, the compression force restricts linear motion of the fastener; and a bolster to restrict the rotational movement of the toggle, the bolster further applies the compression force of the torque assembly against an underside of the lid.

According to another aspect, a method for locking a lid, comprising rotatively engaging threads of a fastener with internal threads of a toggle to translate rotational movement of the fastener to linear movement of the toggle, wherein a friction element embedded within a portion of the fastener causes the fastener to apply the rotational movement of the fastener to the toggle; generating a compression force against the fastener in response to mating a torque assembly to an end of the fastener, wherein generating the compression force includes restricting linear motion of the fastener and creating a rotational resistance to the fastener, wherein the compression force is further applied to an underside of the lid; and restricting the rotational movement of the toggle.

### BRIEF DESCRIPTION OF THE DRAWINGS

Reference will now be made to the attached drawings, when read in combination with the following specification, wherein like reference numerals refer to like parts throughout the several views, and in which:

FIGS. 1-3 are schematic illustrations of an operator using a hand tool, including a security driver bit to unlock one or more locking mechanisms of a removable lid, according to one embodiment.

FIG. 4 is a schematic illustration of lock lugs or toggles in a locked position, according to one embodiment.

FIG. 5 is a schematic illustration of lock lugs or toggles in an unlocked position, according to one embodiment.

FIG. 6A is a perspective illustration of the lid with at least one locking mechanism as it would appear inside the vault while the lid was being removed, according to one embodiment.

FIG. 6B is a perspective illustration of the lid with at least one locking mechanism as it would appear inside the vault while the lid was being installed, according to one embodiment.

FIG. 7A is a schematic illustration of the locking mechanism incorporating a bolt friction element, according to one embodiment.

FIG. 7B is a schematic illustration of forces and actions applied to the locking mechanism when an actuation bolt is tightened and the lock lug is in a locked position, according to one embodiment.

FIG. 7C is a cross-sectional view of FIG. 7B, according to one embodiment.

FIG. 7D is a close-up partial cross-sectional view of FIG. 7C, according to one embodiment.

FIG. 7E is a schematic illustration of an alternate method of locking a flange nut to the actuation bolt by use of a lock pin, according to one embodiment.

FIG. 7F is a schematic illustration of a lock lug in a locked position, according to one embodiment.

FIG. 8A is a cross-sectional view of the locking mechanism and partial views of the lid and vault, according to one embodiment.

FIG. 8B is a cross-sectional view of the locking mechanism and partial views of the lid and vault, according to one embodiment.

FIG. 9 is a cross-sectional view of the locking mechanism and partial views of the lid and vault, according to one embodiment.

FIG. 10 is a perspective view of the locking mechanism, according to one embodiment.

FIG. 11 is a cross-sectional view of the removable lid and locking mechanism of FIG. 10, according to one embodiment.

FIG. 12 is an alternate feature to prevent the actuation bolt from being unscrewed from the lock lug after installation in the vault, according to one embodiment.

FIG. 13 is a schematic illustration of the locking mechanism coupled to the lid, in response to an attempt to pry the lid open, according to one embodiment.

FIG. 14 is a schematic illustration of the locking mechanism including the toggle illustrated in a transparent format, according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Embodiments of the present invention relate to lids for underground utility boxes, subsurface wire pull boxes, above ground utility enclosures, above ground wire pull boxes, underground enclosures, manholes, water meter boxes, and gas meter boxes. However, it will be understood that the embodiments described herein are also applicable to other applications requiring tight closure of doors, panels, latches, and the like.

Electricity was made available for mass consumption in the twentieth century, and with that came overhead electricity poles and wires that crowded the skylines. Thereafter, a system of underground trenches and vaults was created to conceal these lines. Utility vaults, or in-ground service boxes with removable lids, house and protect valves and wires for public utility equipment, such as valves for water or natural gas pipes, or switchgears for electrical or telecommunications equipment. Lines for telecommunication, electricity distribution, natural gas, cable television, fiber optics, traffic lights, street lights, storm drains, water mains, and waste water pipes converge in utility vaults. Vaults and lids may be fabricated from various materials including but not limited to steel, cast iron, aluminum, brick, reinforced concrete, and polymers. Vaults are typically covered by lids.

Electrical devices often use copper conductors because of its multiple beneficial properties. Moreover, there is an increased occurrence of copper theft from underground utility vaults in public and private facilities. Copper conductors are run through buried conduit when there is a need to route electrical wiring underground between a power source and electrical devices. Long runs of wiring are limited by the distance they can be pulled. Thus, the runs of wiring are brought to the surface at a junction or pull box. The wiring is pulled from that point to the next box or set of boxes until the run reaches the device or electrical panel. The in-ground pull boxes create access points for installation. However, the pull boxes also create opportunities for thieves to cut and steal the wire from the conduit between the boxes and fixtures.

Damaged wires in electrical systems are hazardous and costly to replace. The cost of replacing the wires far exceeds the value of the material itself. Theft like this results in expensive and time consuming repairs for public utility companies and municipalities, as well as private enterprise. Materials other than copper, such as aluminum, are also a target for thieves.

Historically, there is either inadequate or lack of theft deterrence in prior art utility vault designs. The shape of the vaults is typically rectangular. Some designs employ lids held in place by a pair of lid guides on the underside that engage beneath a lid support lip and hold the lid flush with the top of the utility vault. The lid guides loosely engage the lid support lip and prevent the lid from opening upwards. Moreover, to secure these lids, a bolt-down system is the typical accepted solution. Utility vault manufacturers utilize bolts for securing box lids. Often, a single bolt location is used at the center of one side of the lid. A bolt is threaded into a bracket attached to the inside of the box in alignment with the hole in the lid. As previously described, the lid guides provide the remaining attachment between the lid and the lid support lip. In this prior art system, theft deterrence is accomplished by using fasteners with uncommon drive systems. This system remains problematic for several reasons. First, the loosely engaged lid guides do not hold the lid tightly to the lid support lip. Furthermore, the loosely engaged lid guides allow sufficient clearance for a pry bar to be inserted, the lid removed, and contents removed regardless of whether the bolt is in place or not. Second, the uncommon drive systems' removal tool can now be easily acquired by thieves. Third, the loosely engaged lid guides fail to hold the lid closely to the structure of the vault, increasing noise and accelerating wear on the lid and vault systems. Retrofitting and securing existing utility vaults in the field is difficult because at least one additional threaded bracket for bolting the lid to the box would be necessary. Also, the lid would need to be drilled to match the location of the additional threaded bracket. To secure a vault in this scenario, a unique, customer-specific drive pattern for the vault security bolts would be necessary to prevent unlocking with a commercially available key or driver. In some instances, the hazard of retrofitting a vault lid with additional securing means is tremendous and causes traffic delays and potential hazards to pedestrians and motorists. The cost effectiveness of having municipal or private maintenance crews performing these modifications to the boxes and covers, and sourcing unique custom-made fasteners for use throughout the company or agency are impractical and more expensive than installing a pre-made product that addresses all these issues.

Embodiments of the present invention address the problems found in typical utility vaults as mandated by government agencies for their particular area. The present embodiments of the invention are easily integrated into existing installed utility vaults, with or without installed internal threaded brackets, without field modification to the installed vault. Moreover, the adjustable locking features of embodiments of the invention allow use within a range of lid thicknesses and lid support thicknesses as well as providing effective locking within a range of possible side clearances that may be encountered within a single installation. Also, embodiments of the invention are easily integrated into new boxes without modification to the existing box, or into installed boxes that have damaged threads on bolt-down locations that cannot be easily repaired. Embodiments of the locking utility vault lid described herein successfully address all the issues described above, including reducing cost and time for municipalities and ultimately reducing cost for the tax-payers. Embodiments of the invention provide a solution to these needs and other problems, and offer other advantages over the prior art.

A locking vault lid having an integrated locking system will be described in detail herein. It is configured so it can be installed on a vault of a standard design in use in the public domain, where neither the lid nor the vault will require modification for proper installation and use. Features include adjustable locking means that accommodate and lock to internal vault structures of various depths, positions, clearances, and types. Features also include the ability to lock and unlock with the same tool, and when locking, the further ability to tighten the lid to the structure of the vault after locking means are moved to a locked position. The locking system has design features that may hold the locking means in locked position whether the locking means is tightened or not, and said design features will also hold the locking means in unlocked position when unlocked, for ease of handling during removal and replacement of the lid onto the vault. In a security embodiment, the locking system may employ actuation bolts with heads that have a custom engagement pattern (security actuation bolts) requiring a unique key or driver bit (security driver bit) that can be made for and be unique to each customer, but in any case may be unavailable to the general public and only to customers of record. This unique engagement pattern and security key system may have features that exclude any other key or driver bit from unlocking the system.

The locking utility vault lid described herein employs combined locking and tightening features in addition to many other functional features that make this system work. Security type fasteners, when used as security actuation bolts, are included in this description. In some cases, however, secure actuation bolts may not be needed. In this instance, standard bolts with commercially available screw heads using standard drive systems (e.g., hexagonal, Phillips, Robertson, Torx) may be used. All other functional features as described herein would remain applicable, and any combination of these functional features may be included in embodiments of the present invention system regardless of the inclusion of security type fasteners. For the purposes of this description, the term “locking” can be understood as “locking as a theft deterrent” or, “locking as in being held securely in order to prevent movement in use, with or without considering the possibility of theft deterrence”, or any combination thereof. Aside from the “locking without considering the possibility of theft deterrence” scenario described above, other descriptions herein may refer to a system including custom made or unique security fasteners with a custom engagement pattern which may employ a unique access-controlled security driver bit to unlock.

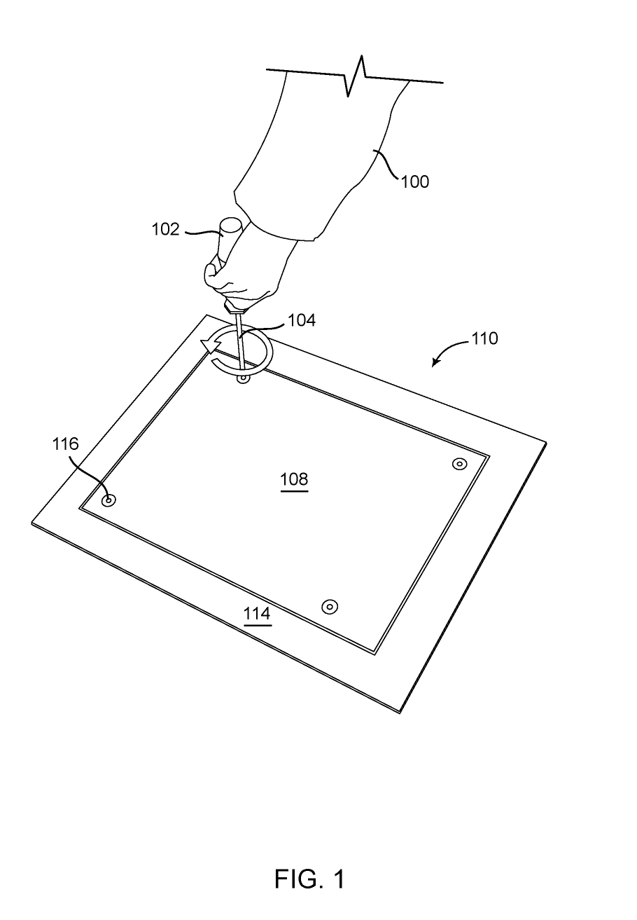

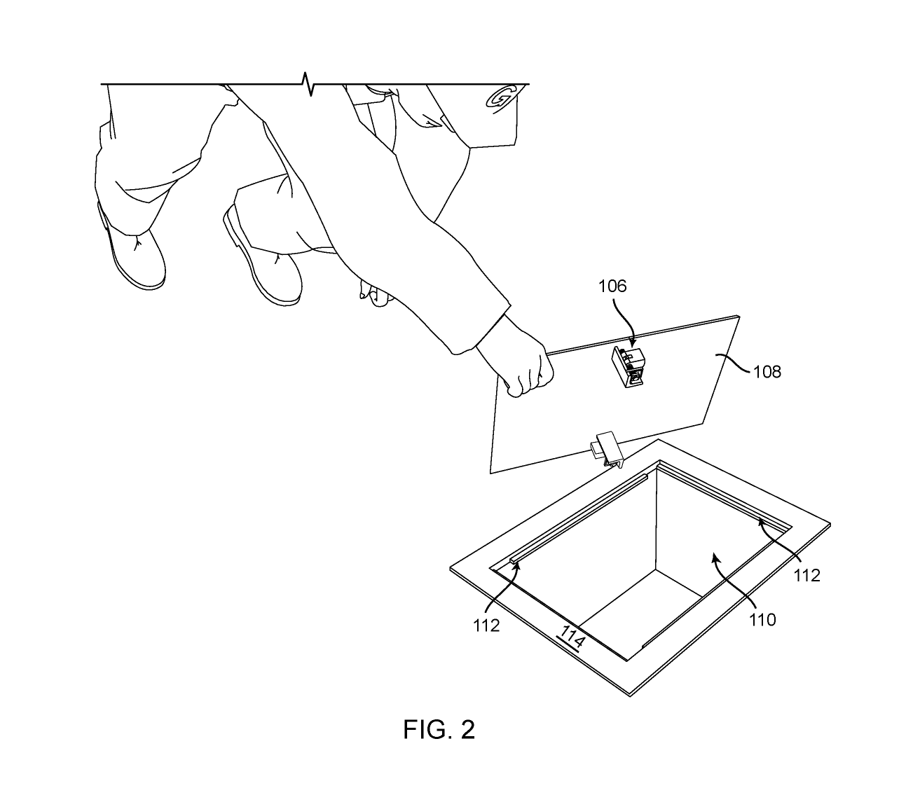

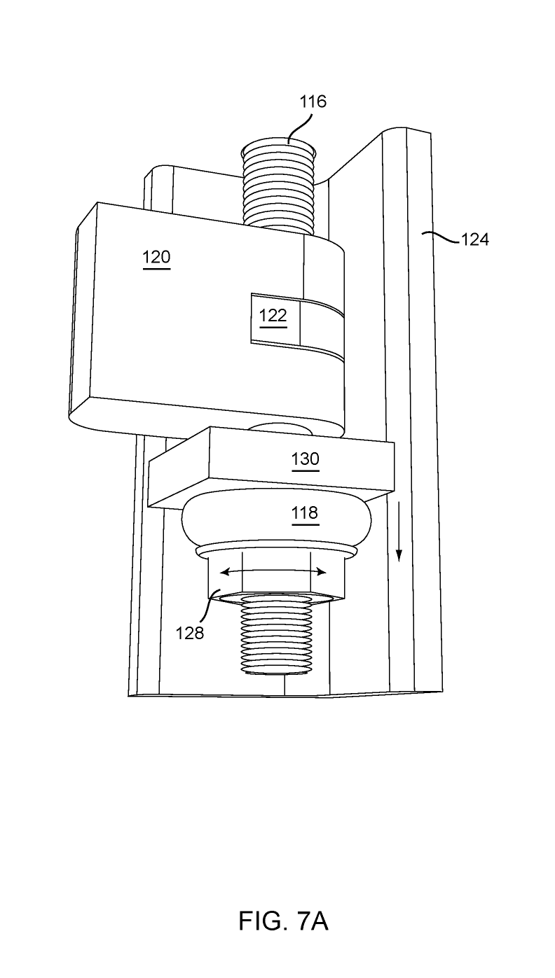

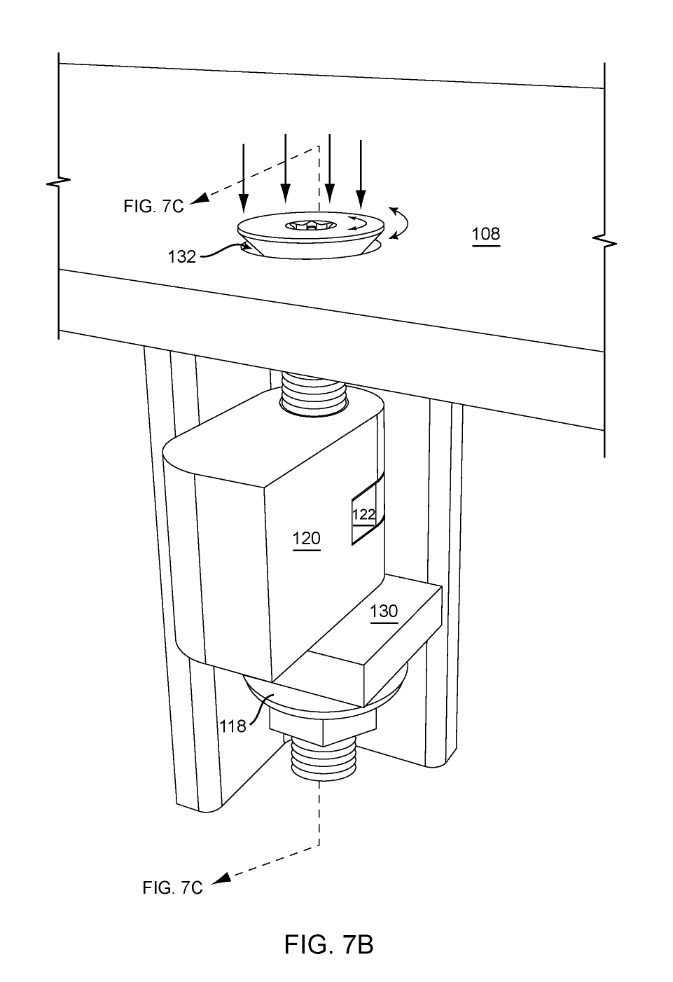

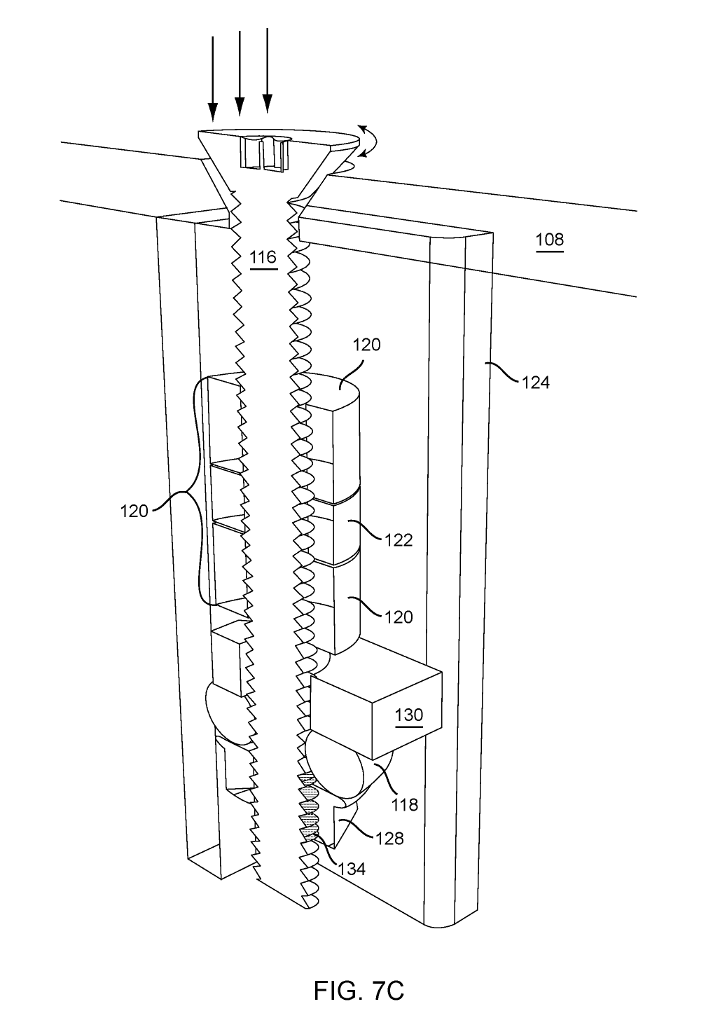

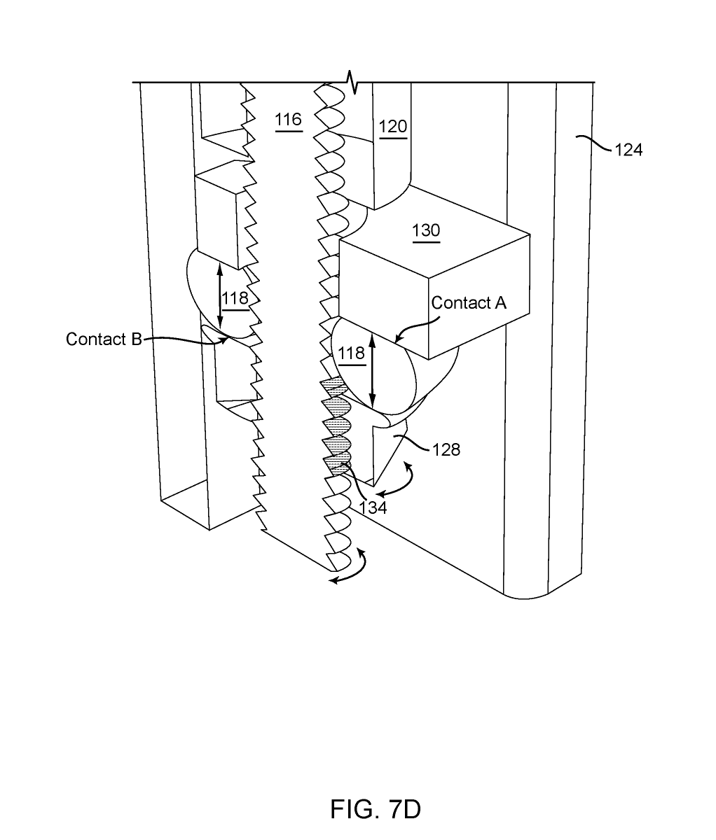

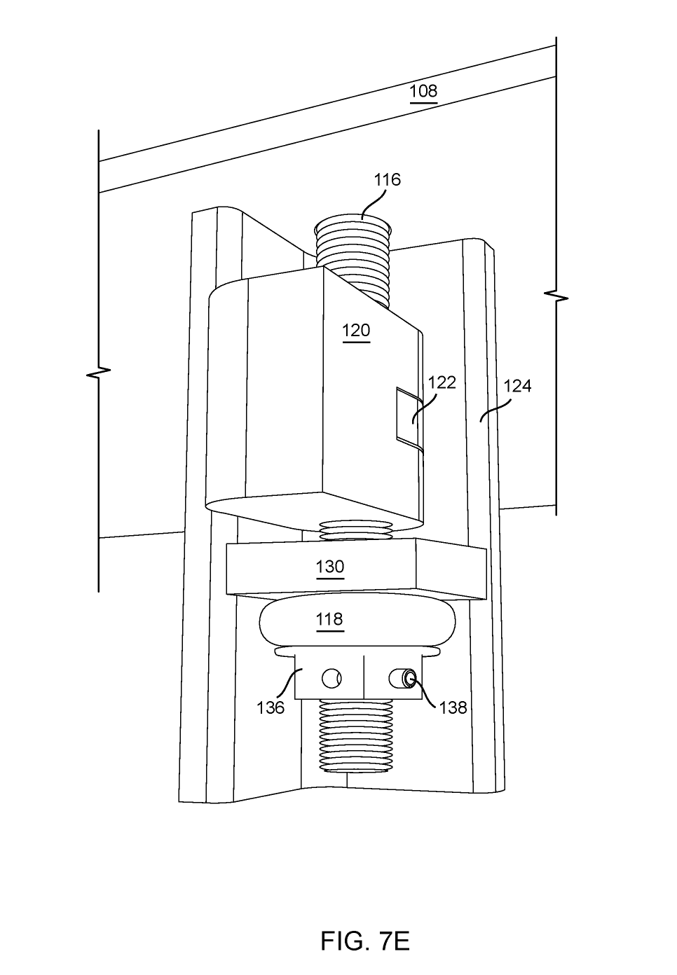

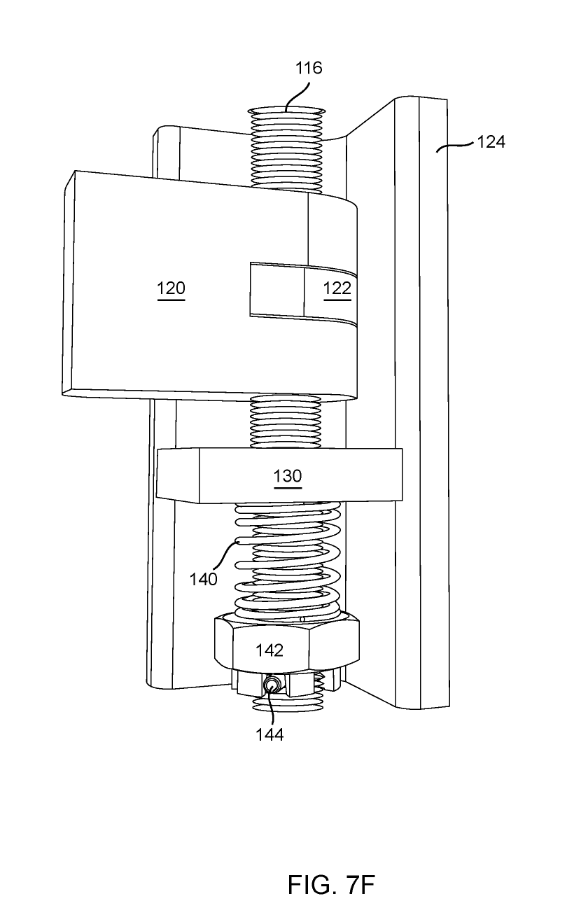

FIGS. 1-3 show illustrations of an operator 100 using a hand tool 102 including a security driver bit 104 to unlock the one or more locking mechanisms 106 of a removable lid 108, according to one illustrated embodiment. FIGS. 1-3 shows embodiments for the removable lid 108 of a utility vault 110 with an integrated locking system. In FIGS. 1-2, the operator 110 uses the special hand tool 102 including the security driver bit 104 to unlock custom security fasteners in a four-lock lid embodiment. It will be understood by those of ordinary skill in the art that in alternative embodiments, less than or more than four locks may be utilized (See, for example, FIG. 2). The position of the locking mechanisms 106 under the lid 108 may vary based on a particular lid 108 size and shape. For example, a rectangular lid 108 may employ two locking mechanisms 106 under each long side. As another example, the lid 108 may employ one or more locking mechanisms 106 along a non-hinged side of the lid 108. It will be understood by those of ordinary skill in the art, that any number of locking mechanisms 106 may be employed as well as varying positioning. In addition, embodiments described herein may include the utility vault lid 108 that may be both locked and tightened to the lid support 112 that support it in the vault 110. A top view of a cover lip plate 114, lid 108, and actuation bolts 116 are shown. In one embodiment, the cover lip plate 114 may, for example, be of steel or similar material with comparable characteristics. It will be understood by those of ordinary skill in the art that cover lip plate 114, lid 108, and actuation bolts 116, may be configured to work together when the vault 110 is in a closed position. As a further description of features and function, the vault system 110 described herein may be in locked but not tightened position, or, in a locked and tightened position. In one embodiment, the vault system 110 may, for example, be in the locked and tightened position. In any case, whether or not the actuation bolt 116 is tightened after locking, the compressible bolt friction and tension element 118 (See, FIGS. 7A-7E) may provide ongoing resistance to turning of the actuation bolt 116, but less resistance than would be generated by tightening a lock lug 120 (or toggle) to an underside of the lid support 112.

The hand tool 102 illustrated in FIG. 1 may have the custom security driver bit 104 with a specifically created engagement pattern for each customer's security actuation bolts 116. The specifically tailored engagement pattern may be one aspect surrounding the security of this locking and removable lid system 110. The security actuation bolts 116, with their special engagement pattern may, for example, be unable to be opened by any other tool aside from the custom security driver bit 104 for a particular customer. The availability of this custom security bit can be made exclusive to and for each customer. For example, the driver bit 104 may, for example, be unavailable to the general public. In other words, the security actuation bolts 116 with their special engagement head pattern and their custom security driver bit 104 creates an exclusive customer-based “key” for the locking removable lid system 110. These key patterns may, for example, be registered in a database, and access may be limited to persons designated by the makers of the locking security vault system 110 described herein. For example, only persons who are authorized may have access to the security driver bits 104. It will be understood by those of ordinary skill in the art that the security driver bit 104 may be operated by hand or used in a hand held power tool. In one embodiment, the security driver bit 104 may be operated by a dedicated holder or tool for the bit 104.

As illustrated in FIG. 1, the operator 100 may unlock the lid 108 by utilizing counter clockwise tool rotation on the security actuation bolts 116. It will be understood by those of ordinary skill in the art that the bolts 116 may be unlocked from the lid 108 by way of the hand tool 102 and security driver bit 102 or other attachment mechanism that may be developed in the future. The security driver bit 102 may be inserted into the bolt 116 to cause rotation of the bolts 116 in order to disengage the lock lug 120 or toggle 120 from the vault. It will be noted that throughout this application reference will be made to lock lug and toggle interchangeably. The lid 108 may then be lifted out of the way. It will be understood that the rotation is not limited to counter-clockwise movement, but may alternatively and/or additionally include clockwise rotation.

Reference is made to FIG. 2, which shows a perspective view of the lid 108 being lifted by the operator 100 by hand. The cover lip plate 114 may be configured to sit on top of the vault 110. It will be understood by one of ordinary skill in the art that the cover lip plate 114 may, for example, be of steel material and may be welded to an internal frame that includes lid supports 112. Additionally, it will be further understood that the top of the frame with the lip plate 114 and lid supports 112 sits flush with the top of the vault 110. It will be understood by those of ordinary skill in the art that the vault 110 and its components may be manufactured from materials such as concrete, steel, aluminum, and composite, but is not limited to those materials. It will be further understood that the lid 108 may be made to meet a range of opening sizes within similarly designed embodiments.

FIG. 2 also illustrates components of the locking mechanism 106. FIG. 2 shows the lock lug 120 rotated to an unlocked position. In one embodiment, the lock lug 120 is rectangular or oval in shape. However, the lock log 102 is not limited to those shapes. In addition, the lock lug 120 could also be a pivoting element, toggle, eccentric cam, wedge, or lock bar.

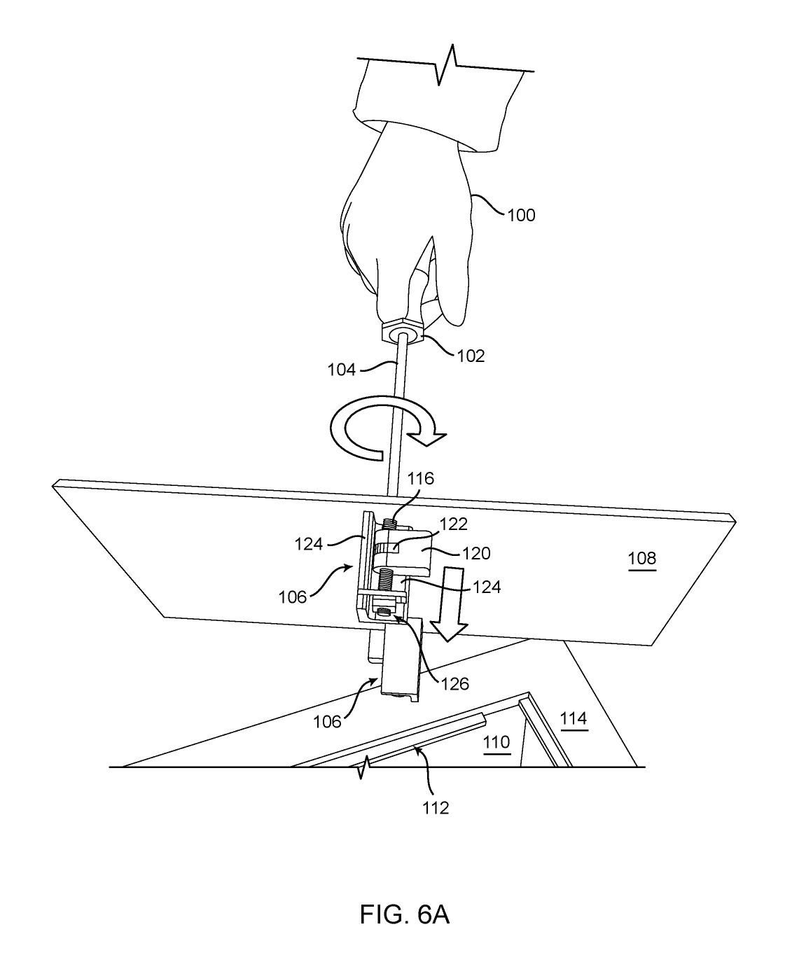

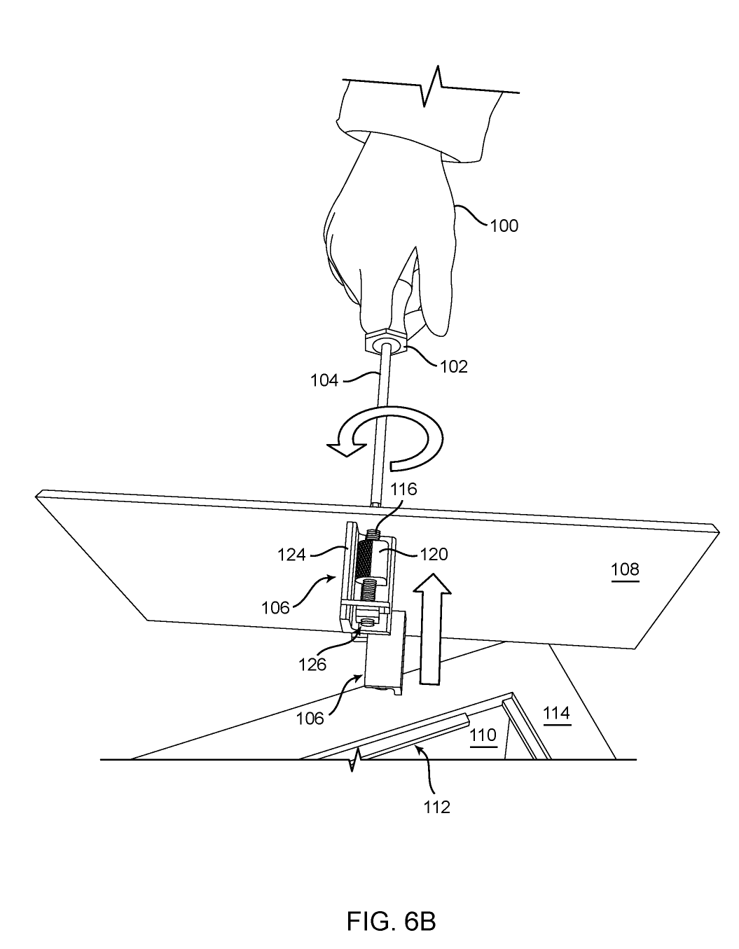

FIG. 6 shows a perspective view of the lid locking mechanism 106 where the operator 100 rotates the hand tool 102 in a counter-clockwise rotation to loosen the actuation bolt 116 and move the lock lug 120 down and away from the lid support 112. Turning of the bolt 116 in tightened position overcomes a lock lug friction element 122 embedded in the lock lug 120. When the lock lug 120 loosens, the lock lug friction element 122 engages the actuation bolt 6 and causes the lock lug 120 to pivot away from the lid support 112. Continued turning of the bolt 116 may cause the lock lug 120 to rotate to the opposite side of an integral rotation stop or bolster 124 and bear against the stop 124. This position allows the lid 108 to be removed from the vault 110.

Furthermore, continued rotation of the bolt 116 in unlocked position overcomes the threaded pivoting lock lug integral friction element 122, such that the lock lug 120 travels axially away from the underside of the lid 108, creating larger clearance between the lock lug 120 and the frame. This allows locking to and unlocking from vaults 110 having varying clearances and thicknesses of steel cover lip plates 114 and lid supports 112.

FIG. 6A illustrates the lock lug 120 in a full, unlocked position after the actuation bolt 116 is turned with the hand tool 102 including the security driver bit 104. FIG. 6B illustrates the bolt 116 turned a quarter turn to unlock the lock lug 120 from the lid support 112. No modification of the vault 110 is necessary to have the locking lid 108 locked and tightened securely to the lid supports 112.

It will be understood by one of ordinary skill in the art that the embodiment illustrated in FIG. 6A occurs inside the vault 110, and a user would not see it until the lid 108 was removed. If the lid 108 were removed, the special hand tool 102 would be set aside while handling the lid 108. Moreover, when the lid 108 is removed, the lock lugs 120 120 stays in this position because the lock lug friction element 122, hold the lock lug 120 to the bolt 116. Because the bolt guide friction element 126 prevents the free rotation of the bolt 116, the lock lug 120 is held in position. As such, further operator 100 action to keep the lock lug 120 in position is unnecessary.

FIG. 6B shows the lid 108 removed from the vault 110, according to one embodiment. In this view, locking actions that occur inside the vault 110 while the lid 108 is installed are shown. The lock lug 120 has been rotated clockwise to the rotation stop (or bolster) 124. In response to the actuation bolt 116 being rotated, the lock lug 120 is tightened against the underside of the lid support 112. This rotation action overcomes the lock lug friction element 124 and pulls the lock lug 120 upwards to pinch the lid support 112 tightly when installed in the vault 110. As a result, the locking components 106 of the lid system are locked in position. This tightening feature further enhances the security of the locking lid system. Tightening prevents the lid 108 from becoming loose in any manner (being loose would be a contrary circumstance in a high security system). Without the ability to tighten, the lock lugs 120 and the lid 108 would not be held tightly in a locked position. Without tightening, the lid 108 would still be locked, however the actuation bolt friction element 126 together with the lock lug friction element 122, which keeps the lock lug 120 engaged with the bolt 116, would keep the lock lug 120 from rotating and becoming unlocked.

FIGS. 1 and 3-5 illustrate a four-lock lid 108 together with a vault 110. FIG. 1 illustrates the lid 108 is in an installed position. The steel cover lip plate 114 is shown surrounding the lid 108 with security actuation bolts 116 rotated to a closed position. The rotated position of the lock lugs 120 is not visible or indicated on the outside. (Having the rotational position of the lock lugs 120 not indicated on the outside of the vault is desirable, and is to be an intentional withholding of information to a potential thief or vandal in that each security actuation bolt 116 would need to be tested or “tried” to determine whether there is an opportunity for removal of the lid 108 in order to steal the lid or the contents of the vault).

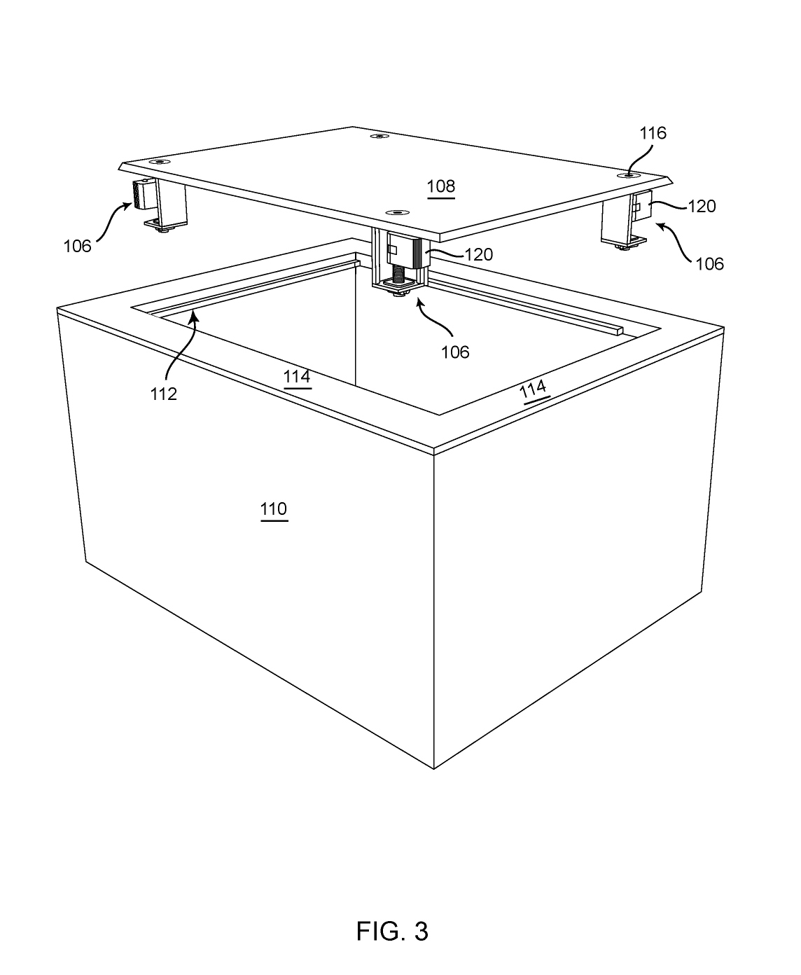

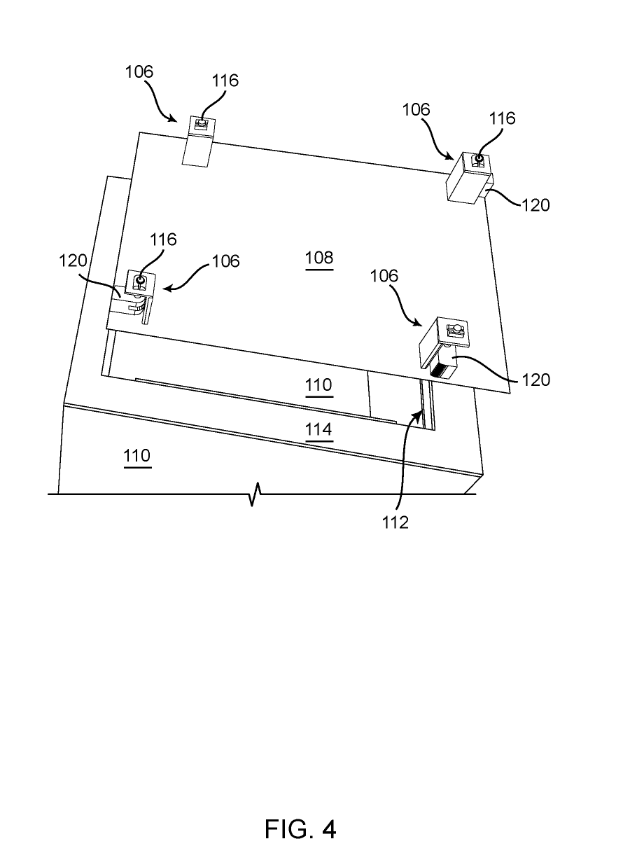

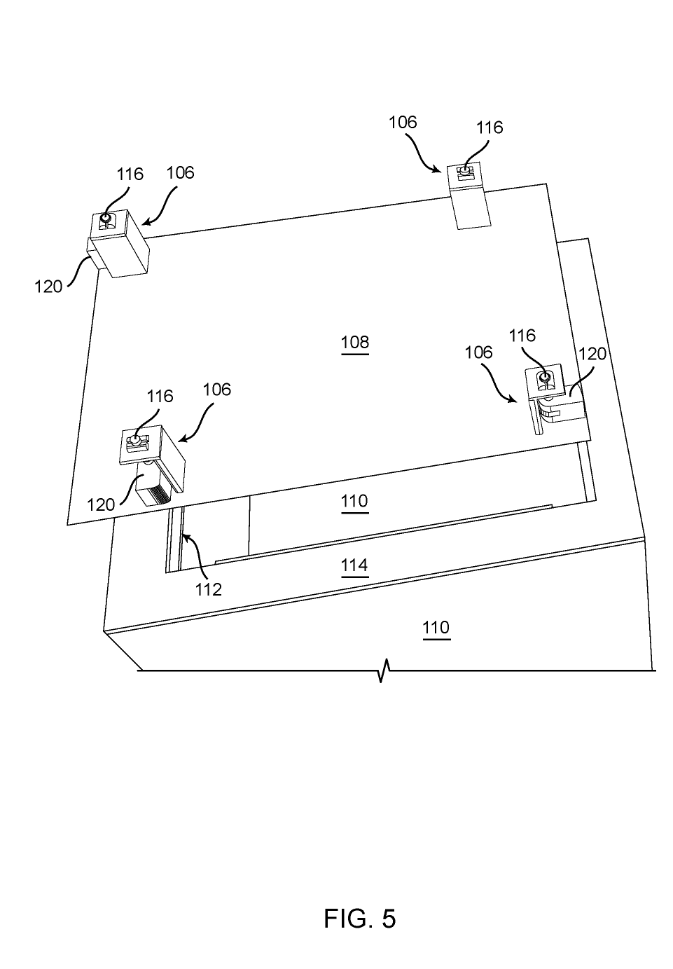

FIGS. 3-5 illustrate top-level perspectives of the vault 110 and lid 108, according to some embodiments. FIGS. 3 and 5 illustrate a four-lock vault 110 with lid 108 in an open position where lock lugs 120 are held in unlocked position, while FIG. 4 illustrates the lock lugs or toggles 120 in a locked position.

FIG. 7A shows locking elements incorporating the bolt friction element 118, according to one embodiment. This embodiment includes a compressible bolt friction and tension element 118 to apply resistance to rotation as well as axial tension. The bolt friction element 118 may, for example, take a form of a washer. Here, a threaded flange nut 128 is threaded onto the actuation bolt 116. The illustrated method for locking the nut 128 in place on actuation bolt 116 (i.e., after tightening and adjusting to a predetermined tension) may include application of a permanent adhesive thread locking material 134 between the threaded flange nut 128 and the actuation bolt 116 threads. This locking material 134 may be of sufficient strength to hold the threaded flange nut 128 securely in place on the actuation bolt 116 regardless of the radial friction or rotational forces encountered while operating the actuation bolt 116.

FIG. 7B illustrates forces and actions applied to the locking components, when the actuation bolt 116 is tightened and the lock lug 120 is in locked position. This embodiment employs compressible bolt friction and tension element 118, and threaded flange nut 128 locked onto the actuation bolt 116. This view illustrates the direction of forces applied to the actuation bolt 116 after the threaded flange nut 128 is tightened against the compressible bolt friction and tension element 118. When the threaded flange nut 128 is tightened against the compressible bolt friction and tension element 118, the force against the compressible bolt friction and tension element 118 and an actuation bolt guide 130 pulls the bolt head down into a countersunk hole 132 in the lid 108. The resulting ongoing axial force applies turning resistance between the lid 108 and the head of the actuation bolt 116, and works together with the bolt guide 130, compressible bolt friction and tension element 118, and threaded flange nut 128 to create rotational control of the actuation bolt 116.

Rotational control of the actuation bolt 116 also creates rotational control of the lock lug 120, as it is held to the bolt 116 by the lock lug friction element 122 onto the bolt 116.

FIG. 7C shows a cross-sectional view of FIG. 7B, where the lock lug 120 is in locked position, according to one embodiment. The compressible bolt friction and tension element 118 may be used. A threaded flange nut 128 is locked onto the actuation bolt 116 with the adhesive thread locking material 134. This view illustrates the direction of force applied to the actuation bolt 116 when the threaded flange nut 128 on the actuation bolt 116 is tightened against the tension and friction element 118 toward the actuation bolt guide 130. The force of tightening the threaded flange nut 128 against the compressible elastomeric tension element 118 toward the actuation bolt guide 130 pulls the actuation bolt 116 downward into the countersink hole 132 in the lid 108. FIG. 7C also shows the path of force applied to the actuation bolt guide 130 and the compressible bolt friction and tension element 118 when the threaded flange nut 128 is tightened and locked in place on the actuation bolt 116. The axial force and radial friction direction and contact areas where the compressible bolt friction and tension element 118 contacts the threaded flange nut 128 and actuation bolt guide 130 are indicated.

FIG. 7D shows a close-up partial cross-sectional view of FIG. 7C, according to one embodiment. The actuation bolt guide 130, compressible bolt friction and tension element 118, and threaded flange nut 128 are shown with indications of axial forces and the resulting radial friction occurring when turning the actuation bolt 116. These forces occur when the bolt 116 is rotated after the threaded flange nut 128 is tightened and adjusted and is locked onto the actuation bolt 116. Contact areas indicated by Contact A and Contact B illustrate where the radial and axial forces interact between the components in this part of the actuation bolt 116 control system.

FIG. 7E shows locking components and an alternate method of locking a flange nut 136 to the actuation bolt 116 by use of a lock pin 138, according to one embodiment. Rotational bolt friction is accomplished by tightening and adjusting the mechanically lockable threaded nut 136 onto the actuation bolt 116 and compressing the compressible bolt friction and tension element 118 against the actuation bolt guide 130. The mechanically lockable threaded nut 136 may be tightened and adjusted before locking to the actuation bolt 116 with the lock pin 138 to allow sufficient rotational friction between the actuation bolt guide 130, the tension and friction element 118, and mechanically lockable threaded nut 136 to prevent free rotation of the actuation bolt 116, while allowing the bolt 116 to be rotated with the proper tools.

FIG. 7F shows the lock lug 120 in a locked position, according to one embodiment. The axial force and rotational friction between components is applied by use of an alternate compressible bolt tension and friction element 140. An alternate style mechanically lockable nut 142 on the actuation bolt 116 is employed. The method of locking the nut 142 in place, for example, after tightening and adjusting to a predetermined tension, may be by use of a lock pin 144. The axial force exerted by the tension element 140 on the actuation bolt guide 130 and the mechanically lockable nut 142 provides axial force and radial turning resistance between these components. This axial force also creates radial friction between the bolt 116 and the countersink hole 132 (the bolt 116 and countersink hole 132 interaction is illustrated in FIG. 7B) in the lid 108.

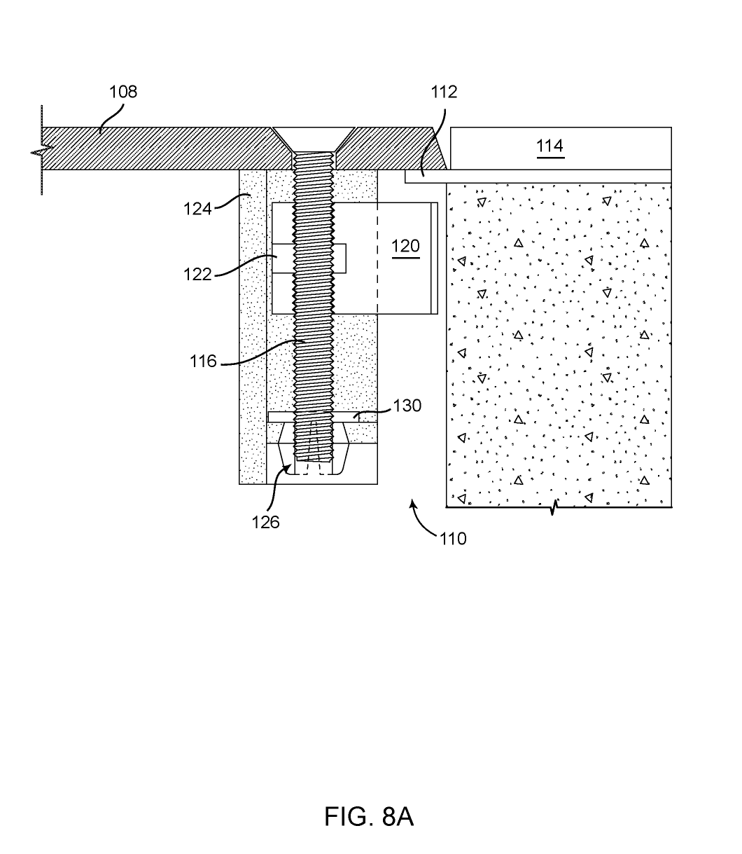

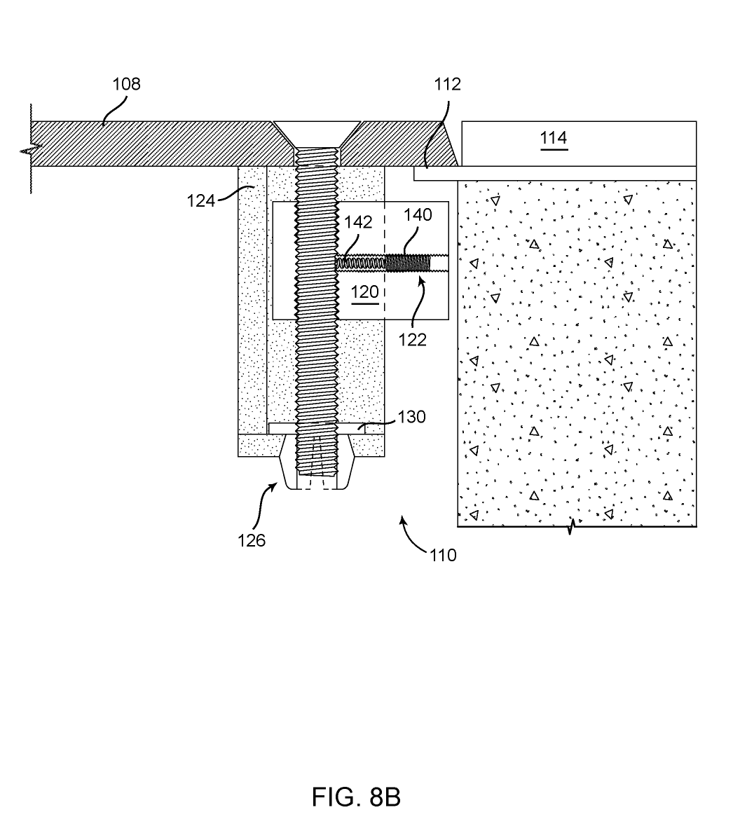

FIG. 8A is a cross-sectional view of the locking lid 108 components, according to one embodiment. The lock lug 120 is in a locked position, but not tightened to the lid support 112. In this embodiment, the bolt guide friction element 126 has three purposes. First, it serves to isolate the actuation bolt 116 from contact with the actuation bolt guide 130, thereby reducing possible damage to the actuation bolt 116 threads in operation. Second, it is to keep the actuation bolt 116 from turning freely (without completely preventing rotation) in either direction. Third, it keeps the actuation bolt 116 in square alignment with the lid 108. In conjunction with the lock lug friction element 122, this will keep the lock lug 120 from rotating and flopping loosely when the lock lug 120 is unlocked and the lid 108 is being removed from the vault. In addition, the bolt guide friction element 126 may provide ongoing resistance to the free turning of the actuation bolt 116 when the lock lug 120 is not tightened to the lid support 112. Resistance to easy turning when the lock lug 120 is not tightened to the underside of the lid support 112 is an additional deterrent to theft. For example, if a thief somehow gets the actuation bolt 116 turned enough to loosen from under lid support 112, it will still be difficult to continue turning the actuation bolt 116 to the full unlocked position without the unique key or driver bit for this actuation bolt 116. Hence, according to embodiments of the present invention, the rotational turning resistance provided by the bolt guide friction element 126 is important to the security of the vault 110 and lid 108. Releasable control of the rotation of the lock lug 120 and the actuation bolt 116 is another feature of this locking system. The lock lug friction element 122 provides releasable attachment between the lock lug 120 and the actuation bolt 116. The lock lug friction element 122 will have both strength and flexibility to assure the attachment between the lock lug 120 and the actuation bolt 116 to assure rotation of the lock lug 120 when needed. Releasable attachment to the bolt 116 will allow the actuation bolt 116 to be turned while the lock lug 120 is stopped against the bolster/rotation stop 124. This will allow the lock lug 120 and lid 108 to be locked and tightened or released from the lid support 112.

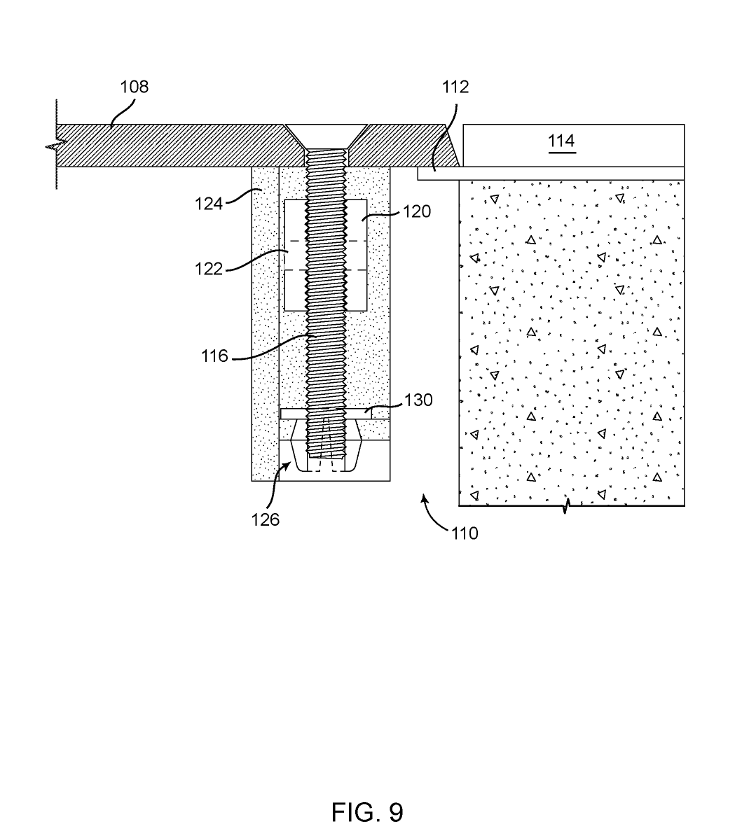

FIG. 9 shows a cross-sectional view of the locking and removable lid 108 system components, according to one embodiment. Here the lock lug 120 is pivoted away from the lock position. The lid 108 can be removed. Here, the lock lug friction element 122 ensures that the lock lug 120 turns when the security actuation bolt 116 is turned. The purpose of the lock lug friction element 122 is to provide assured rotation of the lock lug 120, while still being releasable. This is important because the lock lug friction element 122 must release and allow tightening of the lock lug 120 to the underside of the lid support 112 after the lock lug 120 is prevented from turning past the rotation stop or bolster 124.

Additionally, if the lock lug 120 is tightened to the underside of the lid support 112, the user 100 may remove the lid 108 by using the tool 102 including the security driver bit 104. In response to the user 100 turning the security actuation bolt 116 with sufficient force, the lock lug friction element 122 may slip while the security actuation bolt 116 is loosened. The moment the bolt 116 is sufficiently loose from the lid support 112, the always-engaged lock lug friction element 122 will cause the lock lug 120 to rotate to the rotation stop 124 (e.g., a ¼ turn may be a range of motion needed to rotate the lock lug 120 to an unlocked position. Other embodiments may implement a different amount of rotation to unlock the lock lug 120. In any case, rotating to the rotation stop's 124 unlocked position will be the action taken). The lock lug friction element 122 assures rotation of the lock lug 120 when needed, but will release the actuation bolt 116 from the lock lug 120 during tightening against the lid support 112. The releasable aspect of the lock lug friction element 122 allows tightening of the lid 108 while the lock lug 120 is turned against the rotation stop 124 in the locked position. If the lock lug 120 had no friction element 122 to grip the actuation bolt 116, and was fixed to the actuation bolt 116, the actuation bolt 116 would not be able to tighten the lock lug 120 to the underside of the lid support 112.

FIG. 8B shows a cross-sectional view of the locking removable lid system 110. In this embodiment, the lock lug friction element 122 is embedded within the lock lug 120. The friction element 122 creates friction against the bolt 116 action in this embodiment is accomplished by the tightening of a screw 140. The screw 140 bears upon a spring 142, which in turn bears upon the threads of the actuation bolt 116. The configuration illustrated in FIG. 8B may allow adjustment or replacement of the friction element 122 components, if needed, without replacement of the lock lug 120.

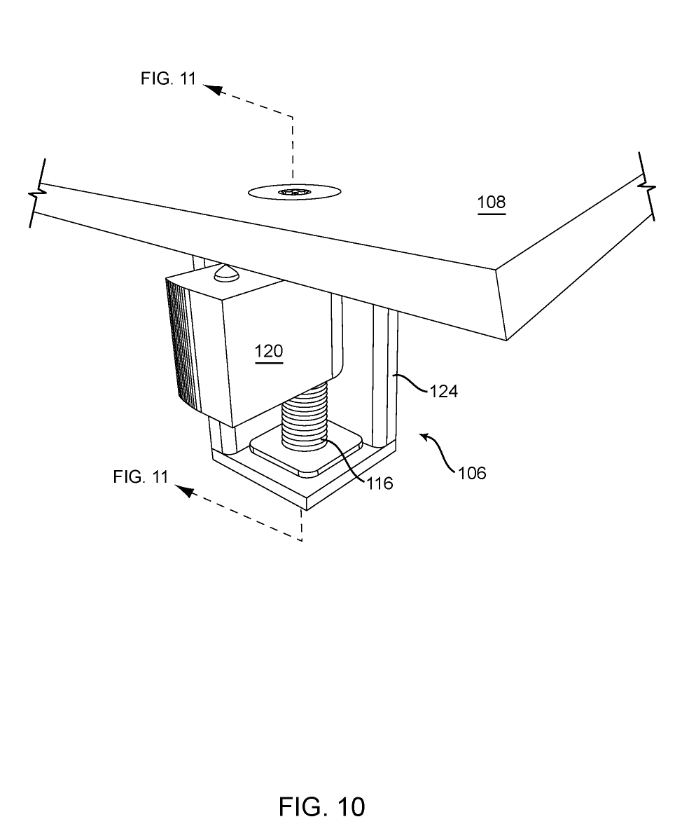

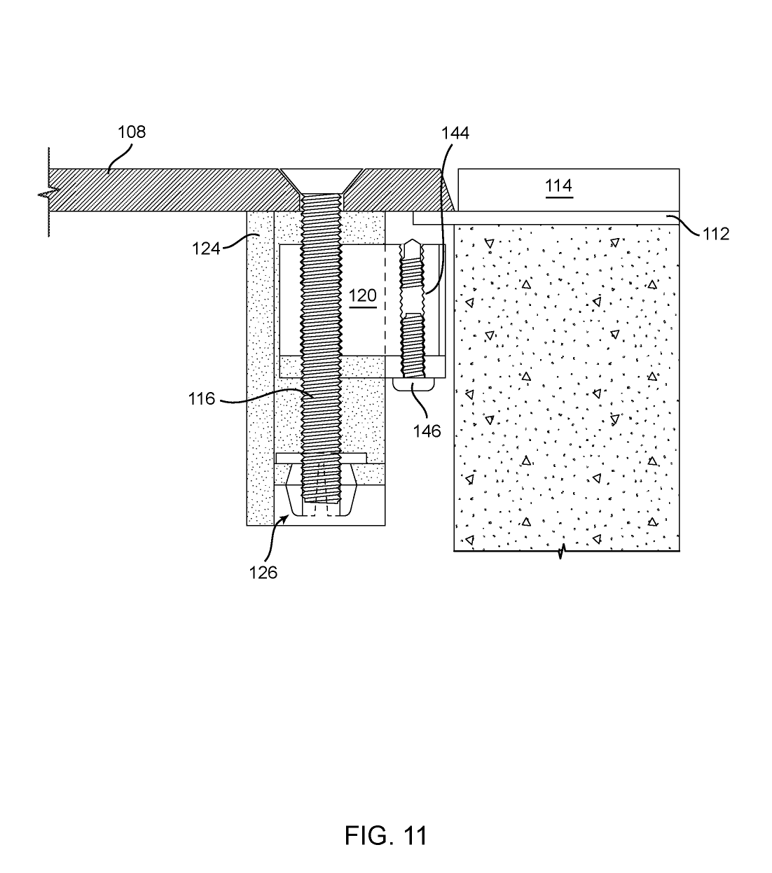

FIG. 11 shows a cross-sectional view of the removable lid 108 and locking mechanism 106 of FIG. 10, according to one embodiment. The lock lug 120 is in a locked position, but not tightened to the lid support 112. An alternate lock lug friction element 144 is fitted to the underside of the lock lug 120 and held in place with a screw 146. This alternate configuration may allow replacement of the friction element 144 by unthreading the actuation bolt 116 and removing the screw 146 holding the friction element 144 in place.

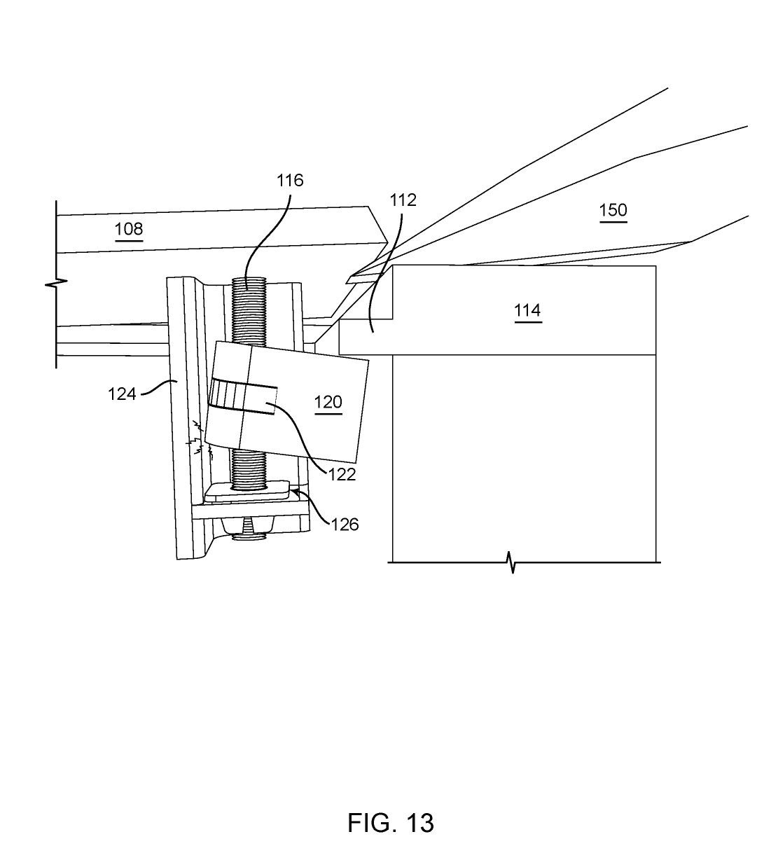

FIG. 13 shows a schematic illustration of the locking mechanism 106 coupled to the lid 108, in response to an attempt to pry the lid 108 open, according to one embodiment. The configuration of the rotation stop 124 acts as a support against tilting of the lock lug 120 to an unlocked position during an attempted defeat by destructive forces. For example, a sharp rigid object 150 may be used to attempt to lift the lid 108 by tilting the lock lug 120. The close proximity of the bolster/rotation stop 124 helps prevent the tilting of the lock lug 120 in the event the lid 108 is able to somehow be pried or levered up from the lid support 112. In an event like this, the bolster/rotation stop 124 may bear upon the lock lug 120 as attempts to defeat the system proceed, to allow very little clearance for the lock lug 120 to move out of its locked position. Prying forces will be transferred to the actuation bolt 116 in a more axial direction than if the lock lug 120 were not supported in this manner. Possibility of bending the actuation bolt 116 is reduced. It will be appreciated, that this is secondary support in keeping the system locked when required.

FIG. 10 is a perspective view of the locking mechanism 106, according to one embodiment. The locking mechanism 106 comprises the lock lug 120 made from semi-ridged material and a design that employs slightly undersize threads cut into the lock lug 120 which creates a high friction (but not locked) condition to grip and hold the threads of the actuation bolt 116. The undersized thread design acts as an integral friction element between the lock lug 120 and the actuation bolt 116. Employing a lock lug 120 having the undersized thread design may eliminate the need for an externally or internally applied lock lug friction element 122, as shown in previous illustrates examples, but may not be suitable for high security situations due to the lower strength of the semi-rigid material employed. The value and simplicity of this design would be useful in the situation where high security and heavy loads will not be an issue. In previously described embodiments, the lock lug friction element 122 was leveraged to assure the rotation of the lock lug 120 by the actuation bolt 116.

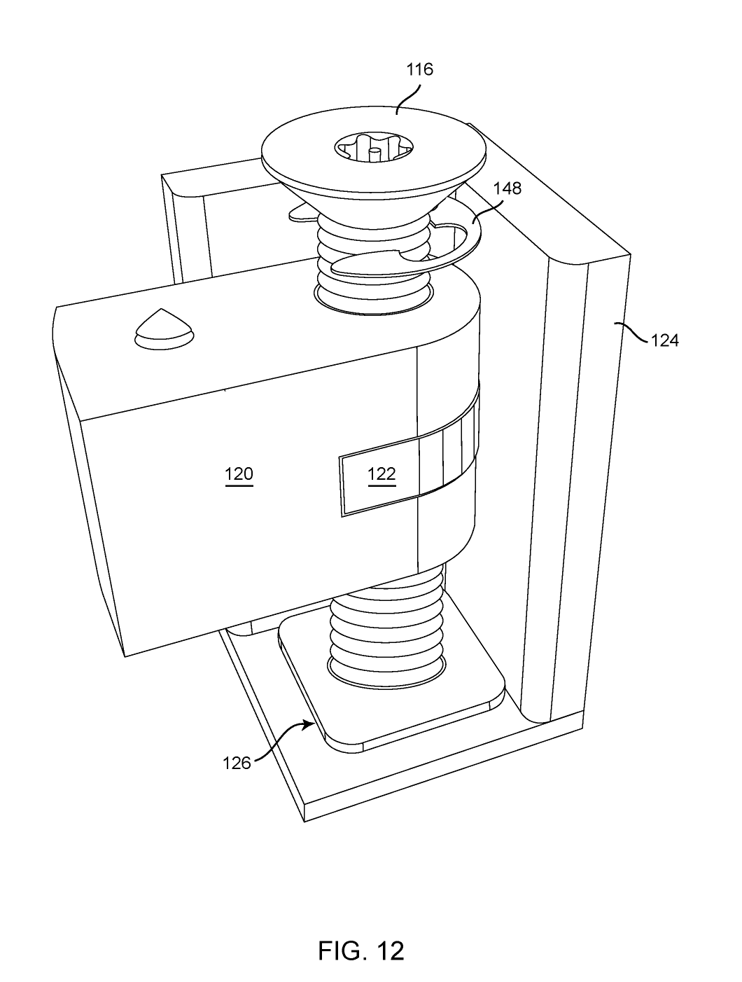

FIG. 12 shows an alternate feature to prevent the actuation bolt 116 from being unscrewed from the lock lug 120 after installation in the vault 110, according to one embodiment. FIG. 12 illustrates a C-clip 148 coupled to the bolt 116 and positioned between the lid support 112 and the toggle 120. This would have value in embodiments where the bolt guide friction element 126 does not retain the bolt from removal. Since the actuation bolt 116 needs only to be turned enough to be loosened from the lid support 112, then turned ¼ turn further to be unlocked, the actuation bolt 116 does not need to be unscrewed from the lock lug 120 and removed from the system.

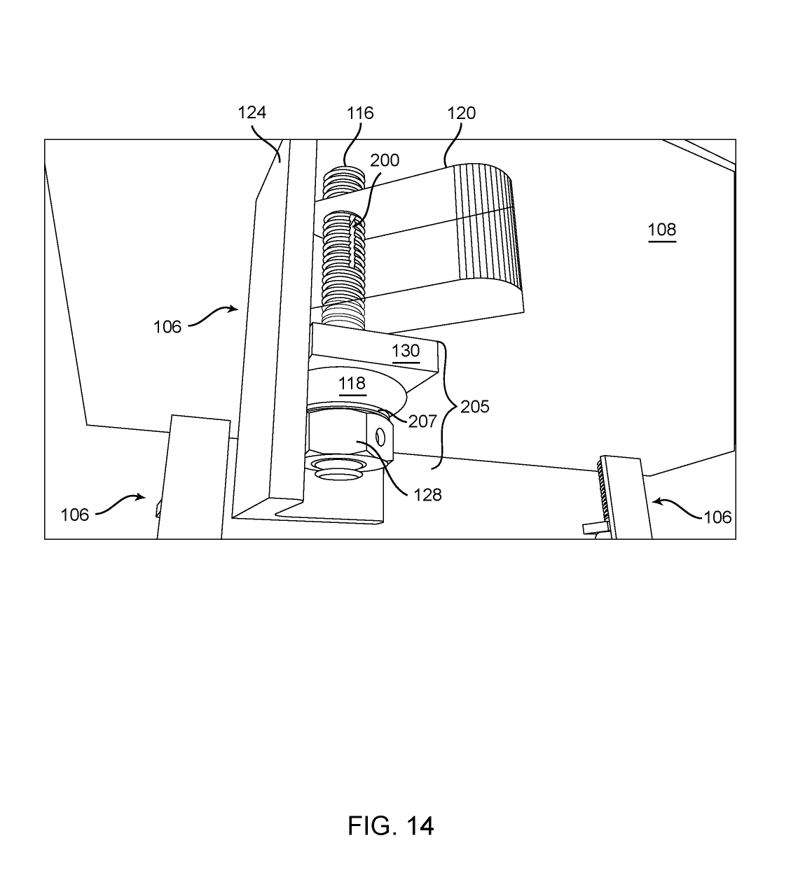

FIG. 14 shows a schematic illustration of the locking mechanism 106 including the toggle 120 illustrated in a transparent format, according to one illustrated embodiment. The locking mechanism 106 comprises the toggle 120 having a threaded hole therein, a fastener 116 such as, for example, the actuation bolt 116, an upper friction element 200, a torque assembly 205, and the bolster 124.

The fastener 116 may be rotatively inserted through the threaded hole of the toggle 120. The toggle 120 may, for example, take the form of a single contiguous piece of steel material having the threaded hole therein. As illustrated, the fastener 116 may have circular threads and, for example, take the form of the bolt 116. The circular threads rotatively engage with the threaded hole of the toggle 120 to convert the rotational movement of the fastener 116 into linear movement of the toggle 120. In other words, as the operator actuates the bolt 116 using, for example, the hand tool 102 with the security driver bit 104, the toggle 120 travels either upward or downward, depending on the direction of rotation of the bolt 116. The bolt 116 may have a head with a unique engraving that allows for the secure driver bit 104 to engage it and actuate. For example, rotating the bolt 116 clockwise may cause the toggle 120 to traverse upwards along the thread of the bolt 116, while a counter-clockwise rotation of the bolt 116 may cause the toggle 120 to traverse downwards. An upwards traversal of the toggle 120 may allow for at least a portion of the toggle 120 to abut against the lid support 112 and thereby lock the vault lid 108, while a downward traversal of the toggle 120 removes the toggle 120 from being abutted against the lid support 112 and thereby unlocks the vault lid 108.

As mentioned above, the fastener 116 or, for example, bolt 116 may comprise the friction element 200 embedded therein. The friction element 200 may be nylon material embedded within a slit through the threads of the bolt 116. Alternatively and/or additionally, other materials with friction characteristics may be painted or otherwise applied to the threads of the bolt 116. For example, the friction element 200 may take the form of a liquid polymer applied to the threads of the bolt 116 and then cured to the bolt 116 threads. The friction element 200 may impart a predictable and consistent amount of friction between threaded components of the locking mechanism 106.

In particular, the friction element 200 causes the toggle 120 to engage the bolt 116 to allow transfer of the rotational movement of the bolt 116 to the toggle 120. As discussed above, rotatively engaging the circular threads of the bolt 116 with the internal threads of the threaded hole of the toggle 120 results in linear movement of the toggle 120. However, as the portion of the threaded bolt 116 having the friction element 200 embedded therein is itself threaded against the threaded hole of the toggle 120, the friction element 200 causes the rotational movement of the bolt 116 to transfer to the toggle 120. As such, at least a portion of the toggle 120 may be actuated to be positioned below the vault lip 112, or actuated to a position where the toggle 120 is completely covered by the vault lid 108. See, for example, FIGS. 4-6B for various illustrations of the locking mechanism 106 having the toggle 120 rotated in varying positions relative the vault lip 112. In addition to allowing translation of the rotational force of the bolt 116 to the toggle 120, the friction element 200 may be effectively overcome to stop the translation of the bolt 116 rotational force to the toggle 120. The toggle 120 may be rotatively disengaged from the bolt 116 to prevent the bolt 116 rotation from rotating the toggle 120 while allowing the bolt 116 to continue rotating as needed. This rotative disengagement may occur in response to the toggle 120 having rotated such that the toggle 120 is stopped against the bolster 124. In other words, rotative disengagement occurs when the force of the bolster 124 against the toggle 120 is greater than the friction force of the friction element 200 that couples the bolt 116 rotation to the toggle 120. If the bolt 116 rotation caused the toggle 120 to traverse upward (locking), then the bolster 124 would stop the toggle 120 from rotating at a position that is at least partially underneath the lid lip 112, but allow the toggle 120 to maintain its linear traversal along the length of the bolt 116. Otherwise, in response to a downward traversal (unlocking) of the toggle 120 along the bolt 116, the toggle 120 rotation may be stopped by the bolster 124 at a position that is entirely underneath the vault lid 108 itself. Even while stopped in the unlock position, the toggle 120 maintains its linear traversal along the length of the bolt 116.

It should be noted that after rotative disengagement of the toggle 120 from the bolt 116 due to stoppage of the toggle 120 at the bolster 124, the toggle 120 may be later rotatively reengaged with the bolt 116 via the friction element 200. For example, reengagement may occur in response to the bolt 116 being actuated to rotate in a direction opposite the rotation prior to stoppage of the toggle 120 against the bolster 124. The toggle 120 would then rotate in the opposite direction until the toggle 120 impacts another side of the bolster 124, which in turn, causes rotative disengagement of the toggle 120 from the bolt 116. Although the toggle 120 may be stopped due to impact with the bolster 124 and become rotatively disengaged from the bolt 116, the toggle 120 may continue to traverse upward or downward along the bolt 116 (direction of linear traversal of the toggle 120 depends on direction of rotation of the bolt 116).

As discussed above, the bolster 124 is configured to restrict the rotational movement of the toggle 120 to align the toggle 120 in either the locked or unlocked position. The bolster 124 may comprise the bolt guide 130 mechanically coupled thereto to serve as a support structure to components comprising the locking mechanism 106. As will be described in more detail below, the bolt guide 124 leverages the compression forces acting upon it to at least: compress the bolster 124 against the underside of the vault lid 108 and substantially prevent linear movement of the bolt 116 during actuation of the locking mechanism 106.

The torque assembly 205 may comprise the bolt guide 130, the bolt friction and tension element 118, the threaded flange nut 128, and optionally a washer 207 between the nut 128 and the bolt friction element 118. In one embodiment, the threaded flange nut 128 may further comprise the lock pin 138 to tighten and adjust the threaded nut 128 onto the bolt 116. In another embodiment, the nut 128 may be replaced by a shaft collar with a setscrew. The setscrew may be configured to tension the shaft collar in place against the bolt 116. As such, the shaft collar can be adjusted as there are changes in pressure and wear. It will be appreciated by those of ordinary skill in the art that any other type of nut assembly may be used to compress against the bolt friction element 118.

The torque assembly 205 may be mated to the end of the bolt 116 that has been rotatively inserted through the threaded hole of the toggle 120. Upon initial installation or mating of the torque assembly 205 to the bolt 116, the nut 128 is rotatively tightened against the bolt friction and tension element 118. This creates a compression force against the bolt guide 130, where the compression force pulls the bolt 116 head downward into the countersunk hole 132 in the lid 108 and compresses the bolster 124 against the underside of the vault lid 108. Upon subsequent actuation of the bolt 116 via the security bit driver 104, the compression force created by the torque assembly 205 against the bolt 116 restricts linear motion of the bolt 116. In other words, the compression force of the torque assembly 205 may restrict the bolt 116 from upward or downward traversal through the threaded hole of the toggle 120. Additionally, the compression force applies rotating resistance to the bolt 116 and this creates rotational control of the bolt 116. There is rotational control because overcoming the rotating resistance of the bolt 116 may be done via the secure driver bit 104 designed to actuate the bolt 116, rather than, for example, using one's fingers or jiggling the lid 108.

Having described some embodiments of the invention, additional embodiments will become apparent to those skilled in the art to which it pertains. Specifically, although reference was made to a “bolt” or “actuation bolt” throughout the specification and drawings, it will be appreciated that the embodiments described herein encompass any type of fastener used to rotatively fasten the locking mechanism components to the vault lid. Furthermore, it will be appreciated that although embodiments described and illustrated herein may, for example, have four locking mechanisms or two locking mechanisms employed to lock the vault lid, any other number of locking mechanisms may be used. Moreover, the positioning of the locking mechanisms underneath the lid is not limited to the illustrations herein, but may encompass any other configuration.

Additionally, throughout this application the terms “lock lug” and “toggle” have been used interchangeably. Although, embodiments of the locking mechanism have been described as applied to a vault lid cover, it will be appreciated that the locking mechanism embodiments can also be applied to any other application requiring a tight seal or closure. For example, the locking mechanism may be applied to seal any door or compartment. As one example, the locking mechanism may be employed to seal doors on automobiles, aircrafts, boats, amusement park rides, and the like.
While the particular methods, devices and systems described herein and described in detail are fully capable of attaining the above-described objects and advantages of the invention, it is to be understood that these are the presently preferred embodiments of the invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “one or more” and not “one and only one”, unless otherwise so recited in the claim.

It will be appreciated that modifications and variations of the invention are covered by the above teachings and within the purview of the appended claims without departing from the spirit and intended scope of the invention.

1. A locking apparatus for a lid, comprising:
a fastener having threads and a friction element embedded within a portion of the fastener, the fastener having a head and an end positioned opposite the head, the head capable of being engaged to rotatively actuate the fastener;
a toggle having a threaded hole therein, wherein the fastener is rotatively inserted through the threaded hole of the toggle, the fastener threads rotatively engage with the threaded hole of the toggle to translate the rotational movement of the fastener into linear movement of the toggle, wherein the friction element causes the toggle to engage the fastener to translate the rotational movement of the fastener to the toggle;
a torque assembly mated to the end of the fastener, wherein the torque assembly applies a compression force against the fastener, the compression force restricts linear motion of the fastener; and
a bolster to restrict the rotational movement of the toggle, the bolster further applies the compression force of the torque assembly against an underside of the lid.

2. The locking apparatus of claim 1, wherein the friction element is embedded within a slit through a portion of the threaded fastener.

3. The locking apparatus of claim 2, wherein the friction element comprising a nylon material embedded with the slit.

4. The locking apparatus of claim 1, wherein the bolster causes the toggle to disengage from the fastener and stop translating the rotational movement of the fastener to the toggle in response to the toggle impacting against the bolster upon rotating in a first direction.

5. The locking apparatus of claim 4, wherein the toggle re-engages the fastener to allow translation of the rotational movement of the fastener to the toggle in response to the toggle rotating in a second direction opposite the first direction.

6. The locking apparatus of claim 1, wherein the bolster restricts the rotational movement of the toggle to a quarter rotation of the toggle.

7. The locking apparatus of claim 1, wherein the torque assembly comprises:
a threaded nut rotatively tightened to the end of the fastener and against a bolt friction element to create the compression force to restrict linear motion of the fastener; and
a fastener guide mechanically coupled to the bolster, the fastener guide having the bolt friction element pressure fastened thereto by the threaded nut, the fastener guide configured to support the fastener in place and to apply the compression force to the bolster, wherein the compression force fastens the bolster against the underside of the lid.

8. The locking apparatus of claim 7, wherein the compression force applies a rotating resistance to the fastener.

9. The locking apparatus of claim 7, wherein the bolt friction element is a urethane material shaped to fit around the fastener.

10. The locking apparatus of claim 7, wherein the threaded nut includes a lock pin embedded therein to tighten and adjust the threaded nut onto the fastener.

11. The locking apparatus of claim 1, wherein the head of the fastener comprises a unique engagement pattern that allows for actuation of the fastener via a unique driver bit.

12. A method for locking a lid, comprising:
rotatively engaging threads of a fastener with internal threads of a toggle to translate rotational movement of the fastener to linear movement of the toggle, wherein a friction element embedded within a portion of the fastener causes the fastener to apply the rotational movement of the fastener to the toggle;
generating a compression force against the fastener in response to mating a torque assembly to an end of the fastener, wherein generating the compression force includes restricting linear motion of the fastener and creating a rotational resistance to the fastener, wherein the compression force is further applied to an underside of the lid; and
restricting the rotational movement of the toggle.

13. The method for locking a lid of claim 12, wherein applying the rotational movement of the fastener to the toggle comprises embedding the friction element within a slit through a portion of the threaded fastener.

14. The method for locking a lid of claim 12, wherein restricting the rotational movement of the toggle comprises impacting the toggle against a bolster upon rotating in a first direction.

15. The method for locking a lid of claim 14, further comprising re-engaging the fastener to the toggle to translate the rotational movement of the fastener to the toggle, in response to rotating the toggle in a second direction opposite the first direction.

16. The method for locking a lid of claim 12, wherein restricting the rotational movement of the toggle comprises restricting rotation of the toggle to a 90 degree rotation.

17. The method for locking a lid of claim 14, wherein generating the compression force against the fastener comprises:
tightening a threaded nut to the end of the fastener and against a bolt friction element; and
mechanically coupling a fastener guide to the bolster, the fastener guide having the bolt friction element pressure fastened thereto by the threaded nut.

18. The method for locking a lid of claim 17, wherein generating the compression force against the fastener further comprises applying the compression force to the bolster, wherein the compression force fastens the bolster against an underside of the lid.

19. The method for locking a lid of claim 17, wherein tightening a threaded nut to the end of the fastener includes drilling a lock pin into the threaded nut.

20. The method for locking a lid of claim 12, wherein rotatively engaging the threads of the fastener with the internal threads of the toggle includes actuating rotation of the fastener using a unique driver bit that matches a unique engagement pattern embedded in a head of the fastener.
